(19) United States
(12) Patent Application Publication
(10) Pub. No.: US 2022/0082409 A1
(43) Pub. Date: Mar. 17, 2022

(54) METHOD AND SYSTEM FOR MONITORING A GAS DISTRIBUTION NETWORK OPERATING AT LOW PRESSURE

(71) Applicant: NANYANG TECHNOLOGICAL UNIVERSITY, Singapore (SG)

(72) Inventors: Abhisek UKIL, Auckland (NZ); Justin DAUWELS, Singapore (SG); Sugunakar Reddy RAVULA, Singapore (SG); Ishaan GUPTA, Singapore (SG); Srivathsan CHAKARAVARTHI NARASIMMAN, Singapore (SG); Mengmeng WANG, Singapore (SG); Payal GUPTA, Singapore (SG)

(21) Appl. No.: 17/424,590

(22) PCT Filed: Jan. 21, 2020
(86) PCT No.: PCT/SG2020/050026

§ 371 Date: Jul. 21, 2021

(30) Foreign Application Priority Data
Jan. 21, 2019 (SG) 10201900529U

(51) Int. Cl. G01D 4/00; H04W 84/18; G16Y 10/35; G06Q 50/06; H04L 29/08

(52) U.S. Cl. CPC G01D 4/002; H04W 84/18; G06N 20/00; G06Q 50/06; H04L 67/12; G16Y 10/35

(57) ABSTRACT

A method of monitoring a gas distribution network operating at low pressure, using at least one processor, is provided. The method includes: obtaining sensor data from a plurality of sensors in the gas distribution network configured to detect at least one characteristic of gas flow through the gas distribution network; extracting at least a first type of features from the sensor data; detecting one or more anomalies in the gas distribution network based on at least the first type of features extracted; and determining a location of the one or more anomalies in the gas distribution network based on at least the first type of features extracted. A corresponding system for monitoring a gas distribution network operating at low pressure is provided.

This application claims the benefit of priority of Singapore Patent Application No. 10201900529U, filed on 21 Jan. 2019, the content of which being hereby incorporated by reference in its entirety for all purposes.

### TECHNICAL FIELD

The present invention generally relates to a method of monitoring a gas distribution network operating at low pressure, and a system thereof, and more particularly, for detecting and locating one or more anomalies in the gas distribution network.

### BACKGROUND

Robust and real-time condition monitoring of the underground gas distribution network, which is low pressure, is critical for, for example, interruption-free power generation. However, conventional methods and systems are mostly developed for detecting anomalies (e.g., incidents or events) in high-pressure gas transmission level pipeline networks. For example, various conventionally adopted approaches include:
Acoustic Pressure Waves methods, which may be applied in high-pressure transmission pipelines in order to analyze the waves produced by the rarefaction generated by a leak;
Balancing methods, which may be used in the steady state to monitor the gas flow in a differential analysis via flowmeters disposed at different measure points;
Statistical methods, which may exploit the pressure/flow data analysis for detecting a leak;
Real-Time Transient Models, which may be based on mathematical algorithms processing the gas flow within a pipeline on the basis of the classical mechanics;
Infrared thermographic pipeline analysis, which may exploit the thermal conductance difference between the transported fluid and the dry soil to detect the leak location; and
Acoustic emission detectors, which may allow the detection of a low frequency acoustic signal generated by a leak, in high-pressure transmission pipelines.

Furthermore, conventional leak detection methods require intensive human involvement, without mature automation. In addition, they tend to rely heavily on customer reports of gas service problems, instead of direct detection. As also mentioned above, conventional approaches for detecting anomalies are mostly directed to high-pressure transmission network, which do not address a number of problems specific to low-pressure distribution network. For example, there may be SCADA (supervisory control and data acquisition) systems for monitoring the distribution network but they fail to provide an easy-to-use system, which delineates the type, location and duration of incidents. Accordingly, for example, although there may be many conventional leak detection techniques currently in use, but such techniques that work for high-pressure pipelines may not hold true for low-pressure pipelines. For example, since the change in signals of acoustic and infrared signal due to anomalies may not differ significantly, for conventional pressure and flow based techniques, the variations may be suppressed in the gas consumption by the consumers. In this regard, the detection of leaks and other anomalies in pipelines is particularly challenging in the low-pressure range.

A need therefore exists to provide a method of monitoring a gas distribution network operating at low pressure, and a system thereof, that seeks to overcome, or at least ameliorate, one or more problems relating to low-pressure gas distribution network. It is against this background that the present invention has been developed.

### SUMMARY

According to a first aspect of the present invention, there is provided a method of monitoring a gas distribution network operating at low pressure, using at least one processor, the method comprising:

obtaining sensor data from a plurality of sensors in the gas distribution network configured to detect at least one characteristic of gas flow through the gas distribution network;

extracting at least a first type of features from the sensor data;

detecting one or more anomalies in the gas distribution network based on at least the first type of features extracted; and

determining a location of the one or more anomalies in the gas distribution network based on at least the first type of features extracted.

According to a second aspect of the present invention, there is provided a system for monitoring a gas distribution network operating at low pressure, the system comprising:

a memory; and

at least one processor communicatively coupled to the memory and configured to:
obtain sensor data from a plurality of sensors in the gas distribution network configured to detect at least one characteristic of gas flow through the gas distribution network;
extract at least a first type of features from the sensor data;
detect one or more anomalies in the gas distribution network based on at least the first type of features extracted; and
determine a location of the one or more anomalies in the gas distribution network based on at least the first type of features extracted.

According to a third aspect of the present invention, there is provided a computer program product, embodied in one or more non-transitory computer-readable storage mediums, comprising instructions executable by at least one processor to perform a method of monitoring a gas distribution network operating at low pressure, using at least one processor, the method comprising:

obtaining sensor data from a plurality of sensors in the gas distribution network configured to detect at least one characteristic of gas flow through the gas distribution network;

extracting at least a first type of features from the sensor data;

detecting one or more anomalies in the gas distribution network based on at least the first type of features extracted; and

determining a location of the one or more anomalies in the gas distribution network based on at least the first type of features extracted.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a flow diagram of a method of monitoring a gas distribution network operating at low pressure, according to various embodiments of the present invention;

FIG. 2 depicts a schematic block diagram of a system for monitoring a gas distribution network operating at low pressure according to various embodiments of the present invention, according to various embodiments of the present invention;

FIG. 3 depicts a schematic block diagram of an exemplary computer system which may be used to realize or implement the system as depicted in FIG. 2;

FIG. 4 depicts a schematic flow diagram associated with an example system for monitoring a gas distribution network operating at low pressure, according to various example embodiments of the present invention;

FIG. 5 depicts a flow diagram illustrating an operation flow of the monitoring system in relation to the detection of anomalies, according to various example embodiments of the present invention;

FIG. 6 depicts a flow diagram illustrating an operation flow of the incident classifier, according to various example embodiments of the present invention;

FIG. 7 depicts plots showing the pressure signal during a leak instance and the variation of pressure over time (step change of pressure for different leak sizes), according to various example embodiments of the present invention;

FIG. 8 depicts plots slowing the pressure signal during a water ingress and the ratio of high frequency energy to the total energy of the pressure signal, according to various example embodiments of the present invention;

FIG. 9 depicts a flow diagram illustrating an operation flow of the localization engine, according to various example embodiments of the present invention;

FIG. 10 depicts a handheld device for improving accuracy of the location of an anomaly determined, according to various example embodiments of the present invention;

FIG. 11 depicts a flow diagram illustrating an operation flow associated with the auxiliary localization engine, according to various example embodiments of the present invention;

FIG. 12 depicts an example architecture of a handheld device, according to various example embodiments of the present invention; and

FIG. 13 depicts a flow diagram illustrating an operation flow of the sensor placement engine, according to various example embodiments of the present invention.

### DETAILED DESCRIPTION

Various embodiments of the present invention provide a method of monitoring a gas distribution network operating at low pressure (which may also be referred to herein as low-pressure gas distribution network), and a system thereof, and more particularly, for detecting and locating one or more anomalies in the gas distribution network, that seeks to overcome, or at least ameliorate, one or more problems relating to low-pressure gas distribution network.

In oil/gas industries, an effective way to transport and distribute gas (e.g., natural gas or town gas) is through gas pipeline networks, which may be classified into two categories, namely, a gas transmission network and a gas distribution network. The gas transmission network is operated under high pressure and the gas distribution network may operate under low pressure. In the context of gas transmission network and gas distribution network, the terms “high pressure” and “low pressure” are known in the art and can be understood by a person skilled in the art, and thus need not be specifically defined. By way of examples only and without limitation, in the context of gas transmission network and gas distribution network, high pressure may refer to a range of about 28 bar to about 40 bar and low pressure may refer to a range of about 2 kPa to about 50 kPa. Compared to the gas transmission network, the gas distribution network is typically longer and more complex.

For example, one of the major downfalls of gas pipelines is leak which can be caused by corrosion of pipes, loosening of joints, or third-party damages. Leaks can have critical implications particularly in the case of the gas distribution network since they may be found predominantly in the residential areas. This may be further aggravated in the case of low-pressure underground pipelines, whereby groundwater may enter the pipeline through the leaks. This may eventually block the flow of gas, or even cause internal corrosion, which may be known as a water ingress problem, and typically happens only in low-pressure distribution networks, but not in high-pressure transmission networks. Conventionally, the water ingress in pipelines typically may not be detected until the pipeline is completely blocked by water and the users complain about the lack of gas supply, which may be days after the onset of the problem.

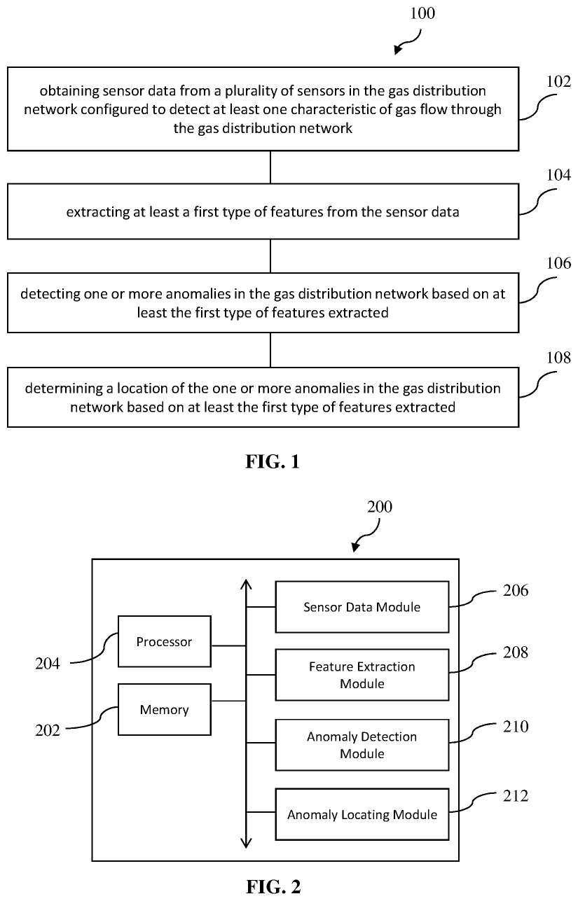

FIG. 1 depicts a flow diagram of a method 100 of monitoring a gas distribution network operating at low pressure, using at least one processor, according to various embodiments of the present invention. The method 100 comprises: obtaining (at 102) sensor data from a plurality of sensors in the gas distribution network configured to detect at least one characteristic (e.g., property or physical parameter) of gas flow through the gas distribution network; extracting (at 104) at least a first type of features from the sensor data; detecting (at 106) one or more anomalies in the gas distribution network based on at least the first type of features extracted; and determining (at 108) a location of the one or more anomalies in the gas distribution network based on at least the first type of features extracted.

Accordingly, in various embodiments, an anomaly in the gas distribution network may be detected and a location of such an anomaly detected may then be determined. In various embodiments, a plurality of anomalies (e.g., at different locations) in the gas distribution network may be detected and a location of each of the plurality of anomalies may then be determined, resulting in a plurality of locations determined for the plurality of anomalies, respectively.

In various embodiments, the above-mentioned extracting (at 104) at least a first type of features comprises identifying a deviation of the sensor data with respect to reference sensor data associated with a reference operating condition (e.g., a desired or a target operating condition) of the gas distribution network.

In various embodiments, the above-mentioned identifying a deviation is further based on supplementary data associated with one or more predetermined factors influencing an operating condition of the gas distribution network away from the reference operating condition.

In various embodiments, the above-mentioned detecting (at 106) one or more anomalies in the gas distribution network comprises identifying one or more types of the one or more anomalies in the gas distribution network using an anomaly classifier based on the at least first type of features extracted. That is, for each of the one or more anomalies detected in the gas distribution network, a type of the anomalies may be identified using an anomaly classifier, such as but not limited, to a gas leak, a water ingress, and so on.

In various embodiments, the anomaly classifier is a machine learning model configured to predict the one or more types of the one or more anomalies in the gas distribution network based on the at least first type of features extracted. That is, for each of the one or more anomalies detected in the gas distribution network, a type of the anomalies may be identified using a machine learning model. In various embodiments, a machine learning model may be trained based on training data (e.g., labelled data) to predict one type of anomaly, and thus, a plurality of machine learning models may be trained for predicting a plurality of types of anomalies, respectively.

In various embodiments, the above-mentioned extracting (at 104) at least a first type of features comprises extracting a plurality of different types of features from the sensor data.

In various embodiments, the above-mentioned detecting (at 106) one or more anomalies further comprises applying a plurality of weights to the plurality of different types of features, respectively, to obtain a plurality of different types of weighted features. In various embodiments, the above-mentioned identifying one or more types of the one or more anomalies in the gas distribution network using the anomaly classifier is based on the plurality of different types of weighted features.

In various embodiments, the above-mentioned determining (at 108) a location of the one or more anomalies in the gas distribution network comprises, for each of the one or more anomalies detected: determining, for each of the plurality of sensors, a probability value of the anomaly occurring in a vicinity of the sensor to obtain a plurality of probability values; and selecting one or more of the plurality of sensors as being in the vicinity of the anomaly based on the plurality of probability values associated with the plurality of sensors. That is, for each of the one or more anomalies detected (e.g., at different locations), a probability value for each of the plurality of sensors is determined, whereby the probability value indicates a probability of the anomaly occurring in a vicinity of the sensor. It will be appreciated by a person skilled in the art that “being in the vicinity” of an anomaly may be predetermined or set as desired or as appropriate, and the present invention is not limited to any particular value or range of values for a sensor to be considered as being in the vicinity of an anomaly. That is, the term “in the vicinity” is clear to a person skilled in the art in this context without requiring a particular value or a range of values to be defined. By way of an example only and without limitation, whether a sensor is determined or considered as being in the vicinity of an anomaly may be based on a distance between a pair of neighbouring sensors. For example, if a pair of neighbouring sensors are positioned a particular distance apart, a sensor may be determined to be in the vicinity of an anomaly if the sensor is located at such a distance apart from the anomaly or less.

In various embodiments, the above-mentioned selecting one or more of the plurality of sensors comprises: grouping multiple sensors of the plurality of sensors, each of the multiple sensors having an associated probability value (i.e., the probability value determined for the sensor as described above) that is within a predefined variation range, to form a group of sensors; and removing one or more of sensors from the group of sensors based on a weighted sum of the probability values associated with the group of sensors. Furthermore, in various embodiments, the location of the anomaly in the gas distribution network is determined as being within a region defined based on the group of sensors.

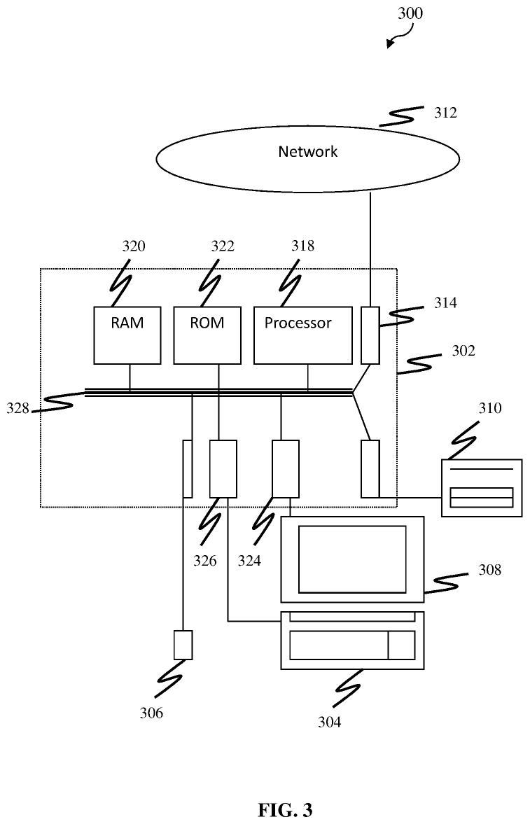

FIG. 2 depicts a schematic block diagram of a system 200 for monitoring a gas distribution network operating at low pressure according to various embodiments of the present invention, such as corresponding to the method 100 of monitoring a gas distribution network operating at low pressure as described hereinbefore according to various embodiments of the present invention. The system 200 comprises a memory 202, and at least one processor 204 communicatively coupled to the memory 202 and configured to: obtain sensor data from a plurality of sensors in the gas distribution network configured to detect at least one characteristic of gas flow through the gas distribution network; extract at least a first type of features from the sensor data; detect one or more anomalies in the gas distribution network based on at least the first type of features extracted; and determine a location of the one or more anomalies in the gas distribution network based on at least the first type of features extracted.

It will be appreciated by a person skilled in the art that the at least one processor 204 may be configured to perform the required functions or operations through set(s) of instructions (e.g., software modules) executable by the at least one processor 204 to perform the required functions or operations. Accordingly, as shown in FIG. 2, the system 200 may comprise a sensor data module (or a sensor data circuit) 206 configured obtain sensor data from a plurality of sensors in the gas distribution network configured to detect at least one characteristic of gas flow through the gas distribution network; a feature extraction module (or a feature extraction circuit) 208 configured to extract at least a first type of features from the sensor data; an anomaly detection module (or an anomaly detection circuit) 210 configured to detect one or more anomalies in the gas distribution network based on at least the first type of features extracted; and an anomaly locating module 212 configured to determine a location of the one or more anomalies in the gas distribution network based on at least the first type of features extracted.

It will be appreciated by a person skilled in the art that the above-mentioned modules are not necessarily separate modules, and one or more modules may be realized by or implemented as one functional module (e.g., a circuit or a software program) as desired or as appropriate without deviating from the scope of the present invention. For example, two or more of the sensor data module 206, the feature extraction module 208, the anomaly detection module 210, and the anomaly locating module 212 may be realized (e.g., compiled together) as one executable software program (e.g., software application or simply referred to as an “app”), which for example may be stored in the memory 202 and executable by the at least one processor 204 to perform the functions/operations as described herein according to various embodiments.

In various embodiments, the system 200 corresponds to the method 100 as described hereinbefore with reference to FIG. 2, therefore, various functions or operations configured to be performed by the least one processor 204 may correspond to various steps of the method 100 described hereinbefore according to various embodiments, and thus need not be repeated with respect to the system 200 for clarity and conciseness. In other words, various embodiments described herein in context of the methods are analogously valid for the respective systems, and vice versa.

For example, in various embodiments, the memory 202 may have stored therein the sensor data module 206, the feature extraction module 208, the anomaly detection module 210, and/or the anomaly locating module 212, which respectively correspond to various steps of the method 100 as described hereinbefore according to various embodiments, which are executable by the at least one processor 204 to perform the corresponding functions/operations as described herein.

A computing system, a controller, a microcontroller or any other system providing a processing capability may be provided according to various embodiments in the present disclosure. Such a system may be taken to include one or more processors and one or more computer-readable storage mediums. For example, the system 200 described hereinbefore may include a processor (or controller) 204 and a computer-readable storage medium (or memory) 202 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of the respective functions which will be described in more detail below may also be understood as a “circuit” in accordance with various alternative embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “obtaining”, “extracting”, “detecting”, “determining”, “identifying”, “selecting”, “grouping”, “removing” or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses a system (e.g., which may also be embodied as a device or an apparatus), such as the system 200, for performing the operations/functions of the methods described herein. Such a system may be specially constructed for the required purposes, or may comprise a general purpose computer or other device selectively activated or reconfigured by a computer program stored in the computer. The algorithms presented herein are not inherently related to any particular computer or other apparatus. Various general-purpose machines may be used with computer programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that the individual steps of the methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention. It will be appreciated by a person skilled in the art that various modules described herein (e.g., the sensor data module 206, the feature extraction module 208, the anomaly detection module 210, and/or the anomaly locating module 212) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, one or more of the steps of a computer program/module or method described herein may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements the steps of the methods described herein.

In various embodiments, there is provided a computer program product, embodied in one or more computer-readable storage mediums (non-transitory computer-readable storage medium(s)), comprising instructions (e.g., the sensor data module 206, the feature extraction module 208, the anomaly detection module 210, and/or the anomaly locating module 212) executable by one or more computer processors to perform a method 100 of monitoring a gas distribution network operating at low pressure as described hereinbefore with reference to FIG. 1. Accordingly, various computer programs or modules described herein may be stored in a computer program product receivable by a system therein, such as the system 200 as shown in FIG. 2, for execution by at least one processor 204 of the system 200 to perform the required or desired functions.

The software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

In various embodiments, the system 200 may be realized by any computer system (e.g., desktop or portable computer system) including at least one processor and a memory, such as a computer system 300 as schematically shown in FIG. 3 as an example only and without limitation. Various methods/steps or functional modules (e.g., the sensor data module 206, the feature extraction module 208, the anomaly detection module 210, and/or the anomaly locating module 212) may be implemented as software, such as a computer program being executed within the computer system 300, and instructing the computer system 300 (in particular, one or more processors therein) to conduct the methods/functions of various embodiments described herein. The computer system 300 may comprise a computer module 302, input modules, such as a keyboard 304 and a mouse 306, and a plurality of output devices such as a display 308, and a printer 310. The computer module 302 may be connected to a computer network 312 via a suitable transceiver device 314, to enable access to e.g., the Internet or other network systems such as Local Area Network (LAN) or Wide Area Network (WAN). The computer module 302 in the example may include a processor 318 for executing various instructions, a Random Access Memory (RAM) 320 and a Read Only Memory (ROM) 322. The computer module 302 may also include a number of Input/Output (I/O) interfaces, for example I/O interface 324 to the display 308, and I/O interface 326 to the keyboard 304. The components of the computer module 302 typically communicate via an interconnected bus 328 and in a manner known to the person skilled in the relevant art.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

Robust and real-time condition monitoring of the underground gas distribution network, which is low pressure, is critical for, for example, interruption-free power generation. According to various example embodiments, advanced monitoring of underground gas pipelines is performed using sensors, such as but not limited to, one or more types of sensors selected from pressure sensors, flow sensors, acoustic sensors, vibration sensors, strain sensors, temperature sensors, chemical sensors and gas sensors, for early detection of one or more anomalies (e.g., incidents or events) in a gas distribution network. By way of examples only and without limitation, types of anomalies in a gas distribution network may include leaks, water ingress, third party intervention, pipe bursts, meter malfunction, changes in gas quality, faulty network devices or regulators, unexpected changes in gas consumption, and so on. According to various example embodiments, using monitored physical parameters, pipeline traceability information and historical data, advanced data analytics are performed for incident identification, localization and predictive maintenance.

In various example embodiments, an overall monitoring system for gas distribution (low-pressure) network (pipeline network) is provided, which relies on a multitude of sensors, as well as communication and data analytics tailored for gas domain. Various problems associated with low-pressure gas distribution network differ significantly from other domains, such as power, communication and traffic networks. For example, various example embodiments provide a solution for predictive maintenance, real-time condition monitoring and optimal sensor placement. For example, the monitoring system according to various example embodiments can be used in conjunction with existing sensing equipment in the pipeline network, and thus, is not device specific.

In various example embodiments, there is provided a hand held diagnostic and analytics device as a user-friendly solution to augment the anomaly localization accuracy. For example, this has been found to be effective for the maintenance crew to locate the anomaly quickly.

It is a challenge to detect anomalies which effect performance of pipelines, such as gas leaks, water ingress, pipe bursts, theft, third party damages, sensor network failures, and so on, in low-pressure distribution network compared to the high-pressure transmission network due to the complexity of network, susceptible to ambient noise.

As explained in the background, conventional leak detection methods require intensive human involvement, without mature automation. In addition, they rely heavily on customer reports on gas service problems, instead of direct detection. In this regard, a real-time monitoring system with analytics for gas distribution network according to various example embodiments eliminates, or at least significantly reduces, the need for expensive and time-consuming human surveillance. Conventional approaches for detecting anomalies are mostly directed to high-pressure transmission network, which do not address many of the problems specific to low-pressure distribution network. For example, there are SCADA systems to monitor the distribution network but they fail to provide an easy-to-use system, which delineates the type, location and duration of incidents. In contrast, the monitoring system according to various example embodiments provides modularity, scalability and interoperability, thereby addressing various problems associated with monitoring and maintenance of gas distribution networks.

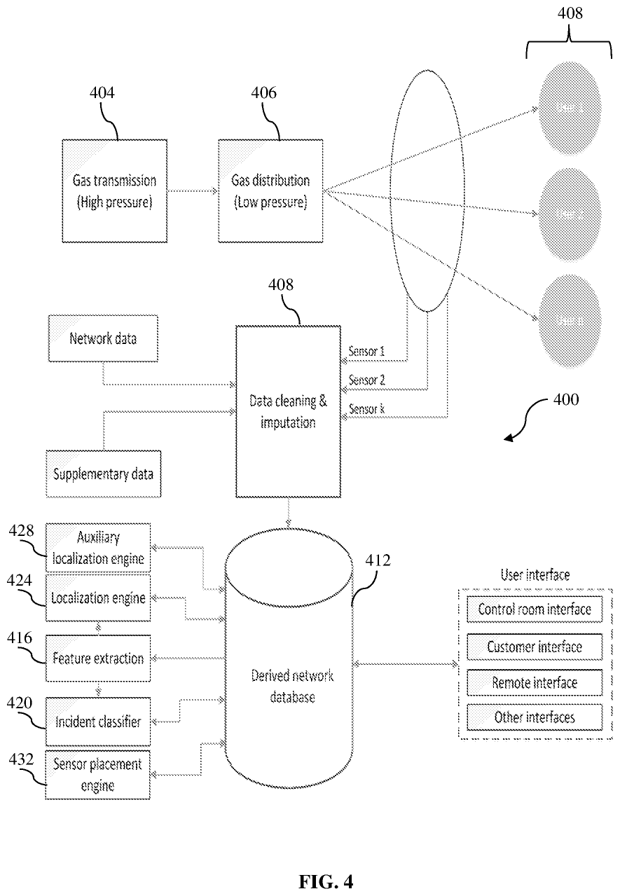

FIG. 4 depicts a schematic flow diagram associated with a system 400 (which may also be referred to as a monitoring system) for monitoring a gas distribution network 406 operating at low pressure, according to various example embodiments of the present invention. As shown in FIG. 4, the gas pipeline network may include a gas transmission network 404 operating at high pressure and a gas distribution network 406 operating at low pressure. For example, gas may be distributed via the gas distribution network 406 to various end user sites 408.

According to various example embodiments, the monitoring system 400 monitors the gas distribution network 406 using a plurality of sensors, such as but not limited to, one or more types of sensors selected from pressure sensors, flow sensors, acoustic sensors, vibration sensors, strain sensors, temperature sensors, chemical sensors and gas sensors. It will be appreciated by a person skilled in the art that the type(s) of sensors used may be determined or selected as desired or as appropriate, and the present invention is not limited to any particular type(s) or number of sensors used. By way of an example only and without limitation, pressure sensors, flow sensors, vibration sensors and/or gas sensors may be used in view of low cost and ease of implementation.

As shown in FIG. 4, a data processing module 408 may obtain sensor data from a plurality of sensors (e.g., sensor 1 to sensor k) positioned in the gas distribution network 406 configured to detect at least one characteristic (e.g., property or physical parameter) of gas flow through the gas distribution network 406. The data processing module 408 (e.g., corresponding to the sensor data module 206 described hereinbefore according to various embodiments) may also be referred to as a data cleaning and imputation module, as shown in FIG. 4. In conjunction with the sensor data, the data processing module 408 may also obtain network data. In this regard, network data may include information relating to various features or physical properties of the gas distribution network 406, such as but not limited to, the location of the sensors, the health of sensors, the operational information relating to the gas distribution network, and various physical properties of the pipes, such as the structure, the type, the length, the diameter and the location of the pipes.

In various example embodiments, the data processing module 408 may further obtain supplementary data, as shown in FIG. 4. The supplementary data may include information relating to one or more predetermined factors influencing an operating condition of the gas distribution network away from the reference operating condition (e.g., a desired or a target operating condition). By way of an example only and without limitation, the supplementary data may include information relating to gas consumption patterns associated with various events, such as holidays or weather.

In various example embodiments, it is noted that the real-time raw sensor data may include transients, which may affect the quality of the sensor data. In this regard, various existing statistical or heuristic cleaning techniques may be adopted to remove these transients from the raw sensor data, such as but not limited to, Kalman or Autoregressive-moving-average model (ARMA) based filtering techniques. After these transients have been removed, they may then be replaced (imputed) with relevant data. This imputation may be done using prevalent probabilistic techniques, such as stochastic regression imputation. For example, the pre-processed data, which is obtained after cleaning and imputation may then be stored in a database on the cloud or a private server. For example, the sensor data may be sent to the database through existing wired/wireless sensor network with any communication architecture and protocols, such as node and mesh architecture with Mobile networks, Wi-Fi, ZigBee, Bluetooth, and so on. The database may include sensor data, network data and supplementary data, which may be stored in any suitable form of database, for example, a relational database, such as but not limited to, MySQL, Oracle, PostgreSQL, and MongoDB. For example, the values in the relational database may be linked using primary keys such as index ID and so on, and may be retrieved using any keys using time stamp, index ID, and so on. For example, the network data may include geographic information system (GIS) information relating to pipelines in the gas distribution network, such as, locations and dimensions of the pipelines. In various example embodiments, the sensor data, the network data and the supplementary data may be pooled together before sending to the derived network database 412 using techniques such as a mesh network or may connect to the server directly and transmit the data such that the data can be organized in the database, for example, using database queries. After the sensor data, the network data and the supplementary data may be stored onto the derived network database 412, relevant features may be extracted by a feature extraction module 416 (e.g., corresponding to the feature extraction module 208 described hereinbefore according to various embodiments) and subsequently used for incident classification by an incident classifier 420 (e.g., corresponding to the anomaly detection module 210 described hereinbefore according to various embodiments) and by an incident localization module or engine 424 (e.g., corresponding to the anomaly locating module 212 described hereinbefore according to various embodiments), which will be described in further details below, according to various example embodiments. The detected incidents and locations of the incidents may be updated in the derived network database 412. In various example embodiments, the placement locations for new sensors may be determined by a sensor placement module or engine, which will be described later below.

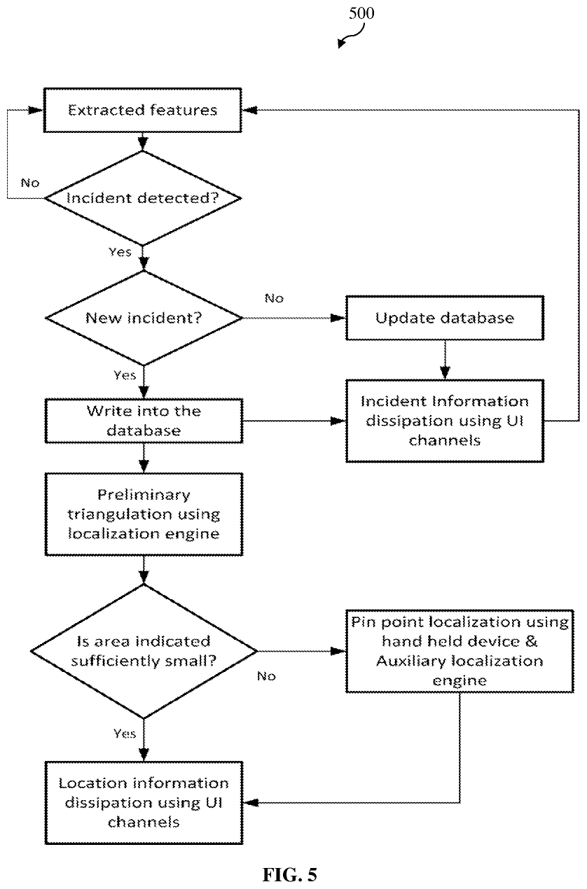

FIG. 5 depicts a flow diagram 500 illustrating an operation flow of the monitoring system 400 in relation to the detection of anomalies, according to various example embodiments of the present invention.

In various example embodiments, after the features are extracted, the monitoring system may detect if an incident has occurred based on the extracted features and whether this is the first instance such an incident has been detected. If the detected incident is found to be the first instance, the detected incident may be written into the database 412 and all subsequent detections of the same incident may be updated in the database 412 until the end of the incident, as shown in FIG. 5. For example, the detection of a new incident helps in identifying multiple incidents which occur at the same time. After a new incident is detected and written into the database as a new incident and updated with existing incident if detected earlier, the localization engine 424 may use the incident identified, along with the extracted features, to start the preliminary identification of the incident location. In various example embodiments, if the area of the location detected after the preliminary identification is considered too large, for example, the area of the location detected is larger than acceptable (e.g., larger than a predetermined size or an acceptable size) for carrying out excavation or performing restoration activity, for example, one pipe segment (e.g., a DN150 pipe segment may have a length of about 7 meters, but different types of pipes may have different lengths), the auxiliary localization engine 424 along with a number of hand held devices may be employed to further narrow down the search space, which will be described in further details later below.

As shown in FIG. 5, in various example embodiments, the incident and location information may be disseminated to the users through user interfaces. For example, the amount of information, the type of interface and features available may be dependent on the user accessing the interface and where the user is accessing it from. For example, this information may be displayed to the relevant user interface, which may be on monitoring computer systems, classified into the customer interface and control room interface for the customers and those monitoring from the control room respectively for a complete overview of the system. For example, the customer interface may provide information about the gas network at their area of residence alone and the control room interface may provide information about the entire region being monitored. For example, the remote interface may be for the maintenance team on the field solving the problem (attending to the anomaly) or installing new sensors, which may be accessed through the handheld device for easy access on the site. This clear delineation of the interfaces provides for optimal information dispersal. Various components of the monitoring system 400 will be described in further details below, according to various example embodiments.

### Incident/Anomaly Classifier 420

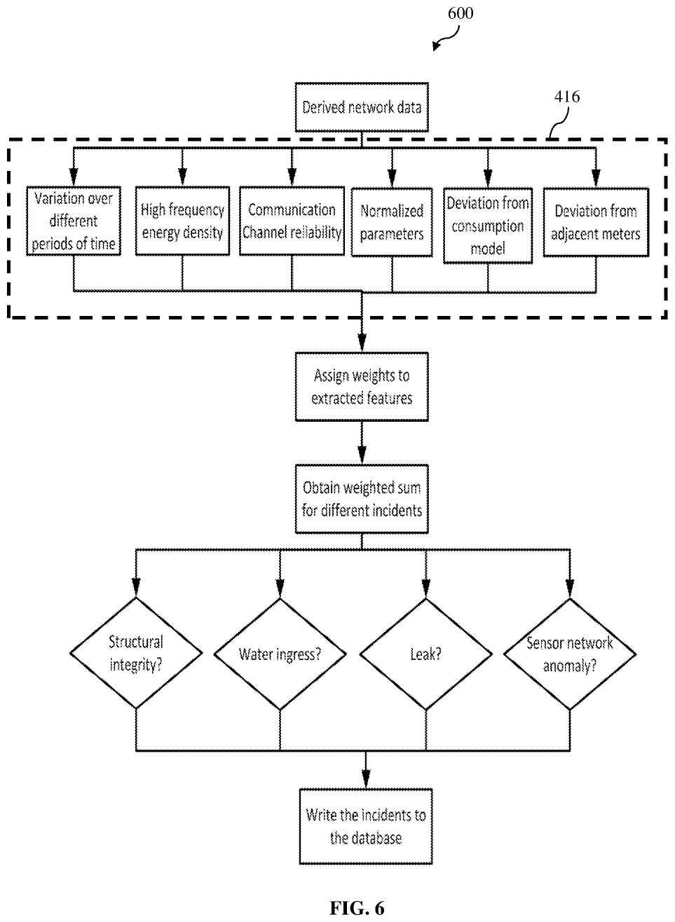

In various example embodiments, the real-time condition monitoring is enabled by the incident classifier 420 shown in FIG. 4. In this regard, the incident classifier 420 is configured to detect various incidents, such as leaks, water ingress, third party intervention, pipe bursts, meter malfunction, faulty network devices or regulators and unexpected changes in gas consumption, based on the extracted features from the derived network database 412. FIG. 6 depicts a flow diagram 600 illustrating an operation flow of the incident classifier 420, according to various example embodiments of the present invention.

In various example embodiments, the feature extraction module 416 may be configured to extract features from the pre-processed data stored in the derived network database 412 that indicate deviations from the corresponding normal baseline of sensor data and uses these features to identify the type, the start and end time, location and severity of the incident. Details about extraction of relevant features are now described below according to various example embodiments. These features may be extracted for individual sensors or between the multiple sensors. In various example embodiments, as shown in FIG. 6, the extracted features may include one or more types of features selected from variation of the sensor data over different periods of time (for example, mean, standard deviation, and so on), the high frequency energy density (for example, ratio of energy in high frequency to the signal energy, which may be obtained based on separation techniques, such as Fourier and wavelet transformation, and so on), communication channel reliability (for example, packets transmission rate, signal strength, and so on), deviation from neighboring meters (for example, difference, standard deviation, and so on), deviation from consumption model (for example, difference, mean square error from model, and so on), and the normalized sensor data (for example, pressure, flow, temperature, and so on).

In various example embodiments, the consumption model for each node (sensor) may be developed through time-series modeling techniques for example Auto Regressive Integrated Moving Average (ARIMA), based on tests conducted emulating the different types of incidents. In various example embodiments, it is noted that the variation of the sensor data over time may be important since the parameters being studied may be predominantly periodic in nature. However, for example, it is noted that the consumption pattern changes when there is a marked change in occupancy (e.g., holidays), weather or other factors influencing consumption. In order to address this issue, according to various example embodiments, consumption models may be developed for each of these conditions and compared based on the current state provided by the supplementary data.

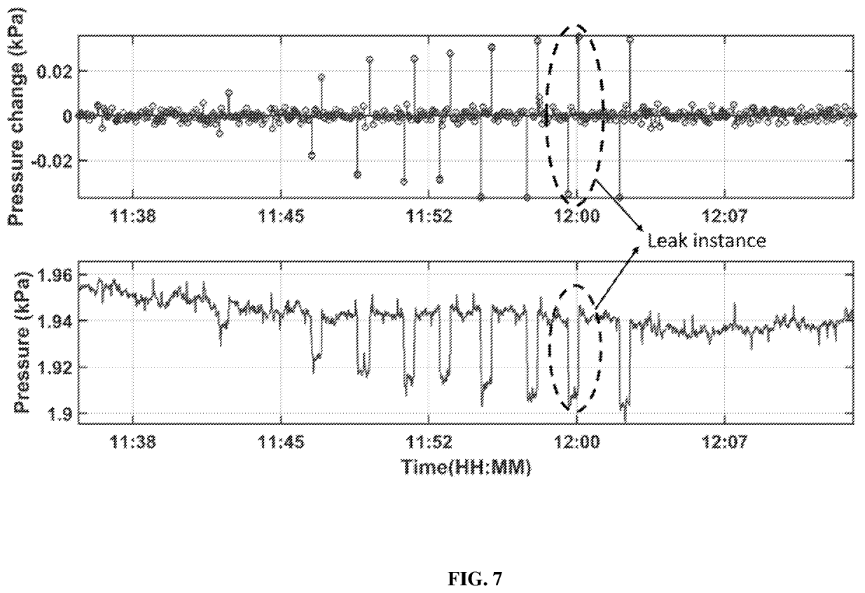

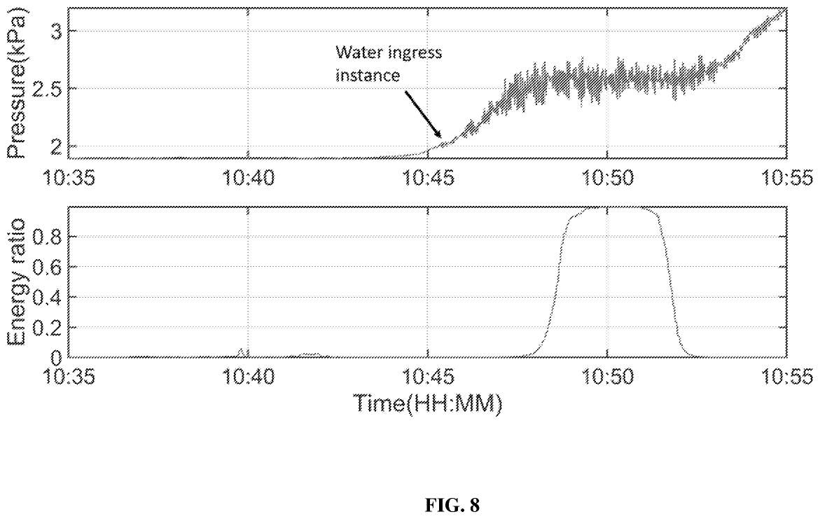

For illustration purpose only and without limitation, examples features used when using pressure meters/sensors are shown in FIGS. 7 and 8. It will be appreciated by a person skilled in the art that the actual features used may vary depending on the parameters being monitored.

In FIG. 7, the bottom plot shows the pressure signal and the upper plot shows the variation of pressure over time (step change of pressure for different leak sizes) calculated by fitting

$$P ( t ) - \overline{P} = \frac{{P}_{c}}{( 1 + {e}^{- k ( t - t 0 )} )} ,$$

where P(t) is the pressure at time t, P̅ is the mean in the window of 10 s, P_{c} is the step change and taken only when |t₀|<0.5, where one of the pressure drops due to leak is denoted by an ellipse. In this regard, the extracted feature (also marked in an ellipse) gives a measure of the start and end of the leak while delineating the difference between the normal condition and the leak condition.

In FIG. 8, the upper plot shows the pressure signal during the water ingress and the lower plot depicts the ratio of high frequency energy to the total energy of the pressure signal. The pressure change due to water ingress is denoted using the arrow. In FIG. 8, the high and low frequencies are split based on the sampling frequency and the frequency of interest, which was observed during water ingress tests. The feature is supposed to be high when the frequency of interest falls in the high frequency region and low when it falls in the low frequency region. The extracted feature may be indicative of the occurrence of water ingress. However, according to various example embodiments, these features themselves may not indicate the occurrence of these incidents beyond doubt. Accordingly, in various example embodiments, in order to make sense of the information (e.g., extracted features, which are shown in FIG. 6), an incident classifier 420 is provided, as shown in FIG. 4. In various example embodiments, these extracted features may then assigned weights using pre-trained machine learning model (e.g., as explained below) for all incidents based on the occurrence over time, whereby the frequency of occurrence lends more weight to a specific feature, then weighted sum calculated for different incident and incidents such as structural integrity, water ingress, leak and sensors anomalies. Accordingly, the weights and the weighted sums may be calculated using machine learning model. In various example embodiments, the incident classifier 420 may be trained (e.g., supervised artificial neural network) based on a repository of labelled data from emulated and actual incidents for all the different types of incidents to be detected by the incident classifier 420. It may utilize machine learning framework to detect and classify the incidents as shown in FIG. 6. The type of anomaly is detected or identified using the incident classifier 420 and this information may then stored on the database. In various example embodiments, a machine learning model may be trained for each type of incident desired to be detected.

### Localization Engine 424

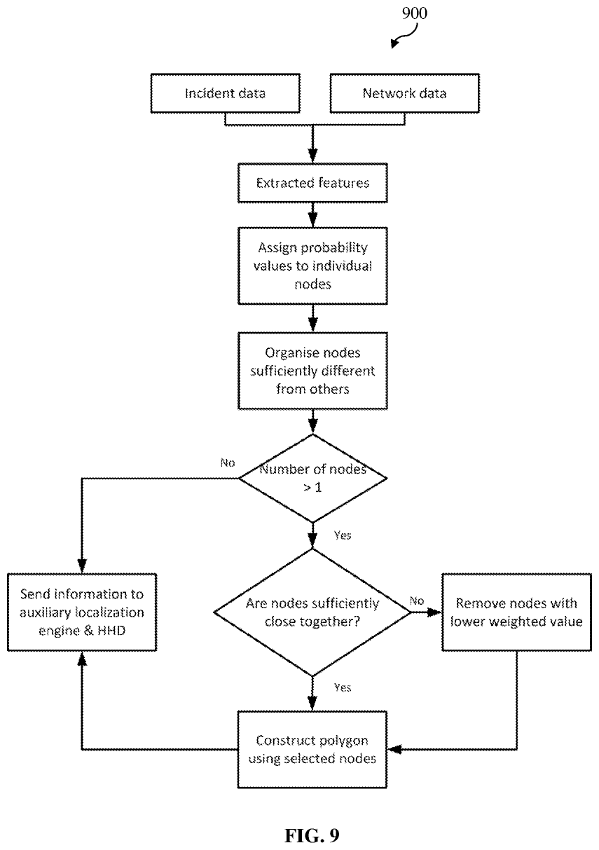

In various example embodiments, the monitoring system 400 further comprises a localization engine 424 configured to determine a location of the anomaly (e.g., incident) in the gas distribution network based on the features extracted. FIG. 9 depicts a flow diagram 900 illustrating an operation flow of the localization engine 424, according to various example embodiments of the present invention.

For example, the gas distribution networks are generally very complex, with multiple redundancies to ensure minimum downtime in case of failures or maintenance. The localization engine 424 may be configured to use the features extracted (e.g., as described hereinbefore) from the incident data and the network data to arrive at possible locations as shown in FIG. 9. A separate set of features can be extracted, similar to the features shown in FIG. 6 as described hereinbefore. Using the extracted features (for the localization engine 424), each sensor (or node) in the gas distribution network is assigned a probability. For example, this may be achieved using a number of techniques known in the art, one such technique involves training the network of nodes based on prior instances of anomalies using machine learning technique such as Bayesian belief network for each type of anomaly. The nodes whose probability values are sufficiently different from the rest are organized together. This may for example use clustering technique or threshold based techniques, and so on. If only one such node is detected then this information is directly sent to the auxiliary localization engine (ALE) and the handheld device (HHD) for the monitoring team to attend to the problem (such as gas leak, water ingress, third party damages or other types of anomalies). If more than one such node is detected, then a weighted sum of probability of the nodes and the distance between them is used to remove outliers. For example, an outlier may be detected if the neighboring distance is 3 times higher than the average distance between the neighboring sensors. Once the outliers are removed, a polygon indicating the location of the incident using the selected nodes is formed and this information is sent to the ALE to be resolved.

### Auxiliary Localization Engine 428

In various example embodiments, the monitoring system 400 further comprises an auxiliary localization module or engine 428 configured to refine the location or area of the anomaly determined by the localization engine 424. In various example embodiments, the auxiliary localization engine 428 may be part of the localization engine 424 (e.g., realized or integrated together). In this regard, in various example embodiments, it is noted that due to, for example, the sparse sensor network, the area detected may still be too large to locate the anomaly (e.g., which may require excavation to resolve the anomaly). For example, in the case of a gas distribution network, due to its proximity to the consumers or residential areas, excavation is a complex, time-consuming process with several obstacles ranging from traffic to obtaining permits from the government. Accordingly, in various example embodiments, in order to improve the accuracy of the location determined by the localization engine 424, such as without adding better and expensive sensors, which adds to the costs of the monitoring system, a handheld device is proposed.

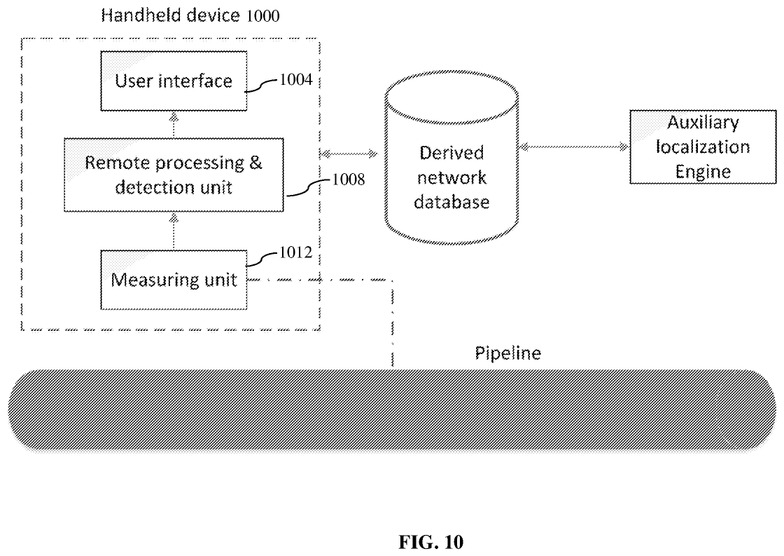

FIG. 10 depicts a schematic drawing of a handheld device (or system) 1000, according to various example embodiments of the present invention. The handheld device 1000 comprises a user interface 1004, a remote processing and detection unit 1008 and a measuring unit 1012. The measuring unit 1012 may be configured to monitor a variety of parameters such as pressure, flow, temperature, vibration and so on, as mentioned hereinbefore. The handheld device collects the sensor parameters, the location using an onboard GPS and compass and user input about access points and number of HHDs. The sensor and location data are then processed on the on-board remote processing and detection unit, which sends this pre-processed information, such as intermediate variables used in the model which detects direction and severity (as will be mentioned hereinafter), to the auxiliary localization engine on the cloud or private server. The advanced, computationally intensive parts such as training and model development may be performed by the auxiliary localization engine on the cloud or private server, which updates this information (pre-processed information, such as derived variables, measurement parameters, smoothened and inputted data, such as described hereinbefore) to the derived network database and eventually to the handheld device as shown in FIG. 10. In various example embodiments, the handheld sensor data may be communicated to the server, cloud or other hubs in the network. This may either be a combination of off-the-self sensor (similar for other sensors) and mobile user interface (IU) (may be communicated directly to the server) or integrated display in the sensor itself (may use the same network for sensor data and display). In various example embodiments, the handheld sensor data may be plugged onto, for example, the pipeline network. This may be plugged in case of pressure or flow touches surface of the pipes for temperature and vibration. In various other embodiments, the handheld sensor may be utilize ultrasonic techniques which may be non-contact based, but essentially measures various parameters directly, and does not calculate from other sensor data.

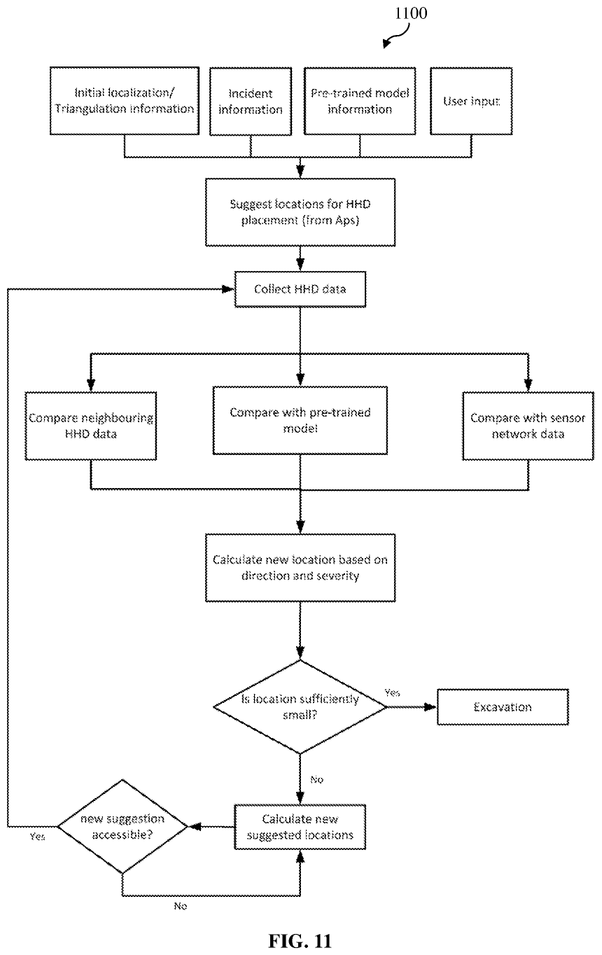

FIG. 11 depicts a flow diagram 1100 illustrating an operation flow associated with the auxiliary localization engine 428, according to various example embodiments of the present invention. The auxiliary localization engine 428 incorporates the initial localization information from the localization engine 424, the incident information, a pre-trained model and user input to narrow down the location information. The pre-trained model refers to a set of models for different types of sensors, different locations (upstream/downstream) and different types of incidents. A series of tests, emulating the anomalies to be detected, are conducted in all the aforementioned cases. The data from these tests is then modelled using time-series modelling techniques such as ARMA modelling. The user input includes the number of maintenance staff, the number of HHDs and the number and location of access points (APs). All of these data are used to suggest initial placement locations for the HHDs, for example, random locations can be generated using no. of APs & HHDs available. The data from the HHDs is collected and compared to the pre-trained models, sensor network data and neighboring HHDs. This information is used to calculate the severity, which is indicative of distance of anomaly and direction (upstream/downstream) using the models which is developed by regression based techniques. The direction and severities can be used to identify the probable location zone using geometry processing techniques for example identifying the zone which lies in-between upstream and downstream. If the new region is sufficiently small (e.g., within a predetermined or acceptable size) for excavation, such as smaller than one pipeline segment, then the excavation for resolving the incident may be started. If not, the auxiliary localization engine 428 may continue to suggest new locations which can be a pre-trained machine learning model (e.g., a supervised neural network), that uses direction and severities to predict new locations, to place the HHDs for the next round of testing until the suggested locations are deemed accessible by the users. The machine learning model can be trained using data about the previous incidents, experiments or through the simulations. This process is repeated until the incident location suggested is narrowed down to a sufficiently small zone.

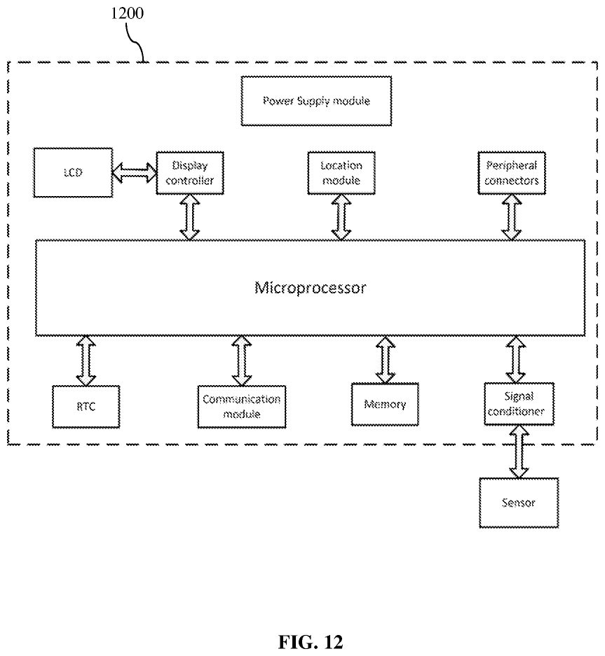

The HHD takes in user input about the number of maintenance staff, the number of HHDs and the number and location of access points (APs) through the LCD touchscreen or through a keypad for input interfaced through the peripheral connectors. The HHDs also transmit their location, determined by the location module, to the ALE to assist in the pinpoint localization of incidents. The location module comprises of a GPS, compass and altimeter to determine and relay accurate location of the MID. The microprocessor has on-board nonvolatile memory and a real-time clock (RTC) for storing the parameter, the incident data and the corresponding time even when the device receives no power. The HHD can connect to different types of sensors, same as those being monitored by the meters installed on the network. All these components are packaged in an explosion proof box, and an example architecture 1200 thereof is shown in FIG. 12 for illustration purpose only and without limitations.

### Sensor Placement Engine 432

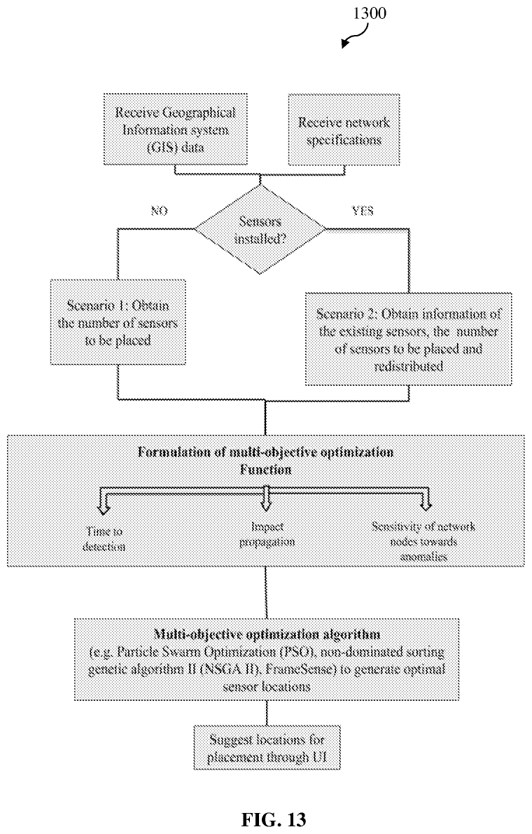

In various example embodiments, the monitoring system 400 further comprises a sensor placement engine 432 configured to determine or propose positions in the gas distribution network for installing a plurality of sensors. FIG. 13 depicts a flow diagram 1300 illustrating an operation flow of the sensor placement engine 432, according to various example embodiments of the present invention. For simplicity and ease of understanding, the case of a leak detection will be described as an example. However, it will be appreciated by a person skilled in the art that the sensor placement engine 432 is also applicable to other types of anomalies which may occur in the gas distribution network. For low-pressure gas distribution networks, a method for sensor placement is provided according to various example embodiments, which includes an ensemble of design objective functions to strategically optimize the position of installed sensors. These objectives include time-to-detection (TTD), sensitivity, and impact propagation (IP).

For example, when a leak occurs, a negative pressure wave propagates from the leak to all reachable nodes in the network. Once a sensor detects the negative pressure, it will flag an alert. This may be referred to as TTD. It is estimated by the velocity of the gas flow and the length of the pipes in the network. For a particular leakage scenario with a given number of sensors, the earliest time of detection from sensor nodes is selected as the TTD.

Sensitivity may be defined as the impact of leakage on the network nodes. In various example embodiments, the gas distribution network with and without a leak are modelled in order to obtain a sensitivity matrix. Assuming that the leak is small compared to the non-leak flows and the network flow equilibrium can be reached in the presence of a leak, the sensitivity matrix is the approximate linear relationship between the residual and the leak.

Impact propagation may assess the impact of leakage on customers. Specifically, it may quantify the affected customers in terms of demand at the time of detection. The impact propagation may be derived from three parameters: time of detection, time of propagation, and the nodal demand. Time of detection may be the time taken from the sensor node to leak node and time of propagation is the time from leak node to the customer location. When the time of detection is slower than the time of propagation, the sensor node detects the leak after it has been propagated to the customers. In this case, the nodal demand at the customer location is added to the impact propagation matrix. Otherwise, the nodal demand at customers' location is not added to the impact propagation matrix.

The goal of the implementation method may be to minimize TTD and impact propagation and maximize the sensitivity. In various example embodiments, a multi-objective optimization method (e.g. Particle Swarm Optimization (PSO), non-dominated sorting genetic algorithm II (NSGA II), FrameSense) may be provided to optimize these objective functions and strategically place the sensors.

Accordingly, a method may be implemented in various example embodiments for determining an optimal location of the sensors for the following example scenarios:

a network without any existing sensors: to install new sensors;

a network with existing sensors placed in non-optimal locations:
to redistribute some of the existing sensors,
to install additional new sensors,
to redistribute some of the existing sensors and install additional new sensors.

In various example embodiments, there is provided a method for installing sensors to detect an anomaly in a low pressure gas distribution network comprising:

a server receiving a map of the gas distribution network from a user;

displaying to the user a list of different types of sensors and a number of sensors to install;

displaying a list of cost objective functions to the user, wherein the cost objective functions include time-to-detection (TTD), sensitivity, and impact propagation (IP);

receiving a ranking priority based on the list of cost objective functions from the user;

the server calculating an optimal sensor placement location in the gas distribution network based on the user input of sensor types, number of sensors and the ranking priority;

and displaying to the user the optimal sensor placement over the map of the gas distribution network;

In various example embodiments, there is provided a method for predicting an occurrence and determining a location of an anomaly in a low pressure gas distribution network comprising:

a server receiving a sensor data indicative of at least one characteristic of gas flow through the gas distribution network;

a user sending an auxiliary data from a handheld device to the server of the characteristic gas flow through the gas distribution network;

the server providing a reference database of sensor data corresponding to a normal state of operation;

the server receiving from a supplementary database relating to a consumption pattern of the gas distribution network;

the server compares the received sensor data and the auxiliary data to the database of reference sensor data and the supplementary database to generate a derived network database which includes:

i. a localization information of the anomaly;

ii. an auxiliary localization information of the anomaly;

iii. an incident classification of the anomaly; and

training the derived network database with historical data of anomalies using a neural network to optimize the localization and incident classification of the anomaly.

In various example embodiments, the anomaly in the low pressure gas distribution network comprises gas leak, water ingress, structural integrity and sensor failure.

In various example embodiments, the sensors comprise pressure, flow, acoustic, vibration, strain, temperature and chemical sensors.

In various example embodiments, the supplementary database comprise data relating to various factors, such as holiday periods and weather, that influences the gas consumption.

In various example embodiments, the incident classification comprises leaks, water ingress, third-party intervention, pipe bursts, meter malfunction, changes in gas quality, faulty regulators and unexpected changes in gas consumption in the gas distribution network.

In various example embodiments, the data from the reference database further may be used to develop mathematical models of the gas monitoring system and training models based on historical data from the sensors of the gas monitoring system.

In various example embodiments, the mathematical models may include models for a normal state of operation.

In various example embodiments, the sensors may be configured to communicate with the server according to a wireless communication protocol, wherein the protocol is WiFi, ZigBee, Z-wave, Bluetooth or mobile network protocols.

In various example embodiments, the derived database classifies the data output for a plurality of user interfaces in the gas monitoring system.

In various example embodiments, the plurality of user interfaces comprises a control room interface, a customer interface and a remote interface.

In various example embodiments, the data from the derived network database may be used to predict the replacement of existing sensors in conjunction with the data provided by the sensors and the reference data.

Accordingly, the monitoring system according to various example embodiments may benefit gas distribution operators to identify any anomalies present in the gas distribution network before the customer complaints. Therefore, the service quality of the gas distribution operators can be improved by applying the monitoring method and system according to various example embodiments of the present invention, such as in one or more of the following ways:
able to provide uninterrupted service to their customers;
manpower saving to localize the anomalies manually;
reduce cost and time to identify and locate leaks in the large network;
reduce wastage of gas resources due to leaks.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of monitoring a gas distribution network operating at low pressure, using at least one processor, the method comprising:
obtaining sensor data from a plurality of sensors in the gas distribution network configured to detect at least one characteristic of gas flow through the gas distribution network;
extracting at least a first type of features from the sensor data;
detecting one or more anomalies in the gas distribution network based on at least the first type of features extracted; and
determining a location of the one or more anomalies in the gas distribution network based on at least the first type of features extracted.

2. The method according to claim 1, wherein said extracting at least a first type of features comprises identifying a deviation of the sensor data with respect to reference sensor data associated with a reference operating condition of the gas distribution network.

3. The method according to claim 2, wherein said identifying a deviation is further based on supplementary data associated with one or more predetermined factors influencing an operating condition of the gas distribution network away from the reference operating condition.

4. The method according to claim 1, wherein said detecting one or more anomalies in the gas distribution network comprises identifying one or more types of the one or more anomalies in the gas distribution network using an anomaly classifier based on the at least first type of features extracted.

5. The method according to claim 4, wherein the anomaly classifier is a machine learning model configured to predict the one or more types of the one or more anomalies in the gas distribution network based on the at least first type of features extracted.

6. The method according to claim 4, wherein said extracting at least a first type of features comprises extracting a plurality of different types of features from the sensor data.

7. The method according to claim 6, wherein
said detecting one or more anomalies further comprises applying a plurality of weights to the plurality of different types of features, respectively, to obtain a plurality of different types of weighted features; and
said identifying one or more types of the one or more anomalies in the gas distribution network using the anomaly classifier is based on the plurality of different types of weighted features.

8. The method according to claim 4, wherein said determining a location of the one or more anomalies in the gas distribution network comprises, for each of the one or more anomalies:
determining, for each of the plurality of sensors, a probability value of the anomaly occurring in a vicinity of the sensor to obtain a plurality of probability values; and
selecting one or more of the plurality of sensors as being in the vicinity of the anomaly based on the plurality of probability values associated with the plurality of sensors.

9. The method according to claim 8, wherein
said selecting one or more of the plurality of sensors comprises:
grouping multiple sensors of the plurality of sensors, each of the multiple sensors having an associated probability value that is within a predefined variation range, to form a group of sensors; and
removing one or more of sensors from the group of sensors based on a weighted sum of the probability values associated with the group of sensors; and
the location of the anomaly in the gas distribution network is determined as being within a region defined based on the group of sensors.

10. A system for monitoring a gas distribution network operating at low pressure, the system comprising:
a memory; and
at least one processor communicatively coupled to the memory and configured to:
obtain sensor data from a plurality of sensors in the gas distribution network configured to detect at least one characteristic of gas flow through the gas distribution network;
extract at least a first type of features from the sensor data;
detect one or more anomalies in the gas distribution network based on at least the first type of features extracted; and
determine a location of the one or more anomalies in the gas distribution network based on at least the first type of features extracted.

11. The system according to claim 10, wherein said extract at least a first type of features comprises identifying a deviation of the sensor data with respect to reference sensor data associated with a reference operating condition of the gas distribution network.

12. The system according to claim 11, wherein said identifying a deviation is further based on supplementary data associated with one or more predetermined factors influencing an operating condition of the gas distribution network away from the reference operating condition.

13. The system according to claim 10, wherein said detect one or more anomalies in the gas distribution network comprises identifying one or more types of the one or more anomalies in the gas distribution network using an anomaly classifier based on the at least first type of features extracted.

14. The system according to claim 13, wherein the anomaly classifier is a machine learning model configured to predict the one or more types of the one or more anomalies in the gas distribution network based on the at least first type of features extracted.

15. The system according to claim 13, wherein said extract at least a first type of features comprises extracting a plurality of different types of features from the sensor data.

16. The system according to claim 15, wherein
said detect one or more anomalies further comprises applying a plurality of weights to the plurality of different types of features, respectively, to obtain a plurality of different types of weighted features; and
said identifying one or more types of the one or more anomalies in the gas distribution network using the anomaly classifier is based on the plurality of different types of weighted features.

17. The system according to claim 13, wherein said determining a location of the one or more anomalies in the gas distribution network comprises, for each of the one or more anomalies:
determining, for each of the plurality of sensors, a probability value of the anomaly occurring in a vicinity of the sensor to obtain a plurality of probability values; and
selecting one or more of the plurality of sensors as being in the vicinity of the anomaly based on the plurality of probability values associated with the plurality of sensors.

18. The system according to claim 17, wherein
said selecting one or more of the plurality of sensors comprises:
grouping multiple sensors of the plurality of sensors, each of the multiple sensors having an associated probability value that is within a predefined variation range, to form a group of sensors; and
removing one or more of sensors from the group of sensors based on a weighted sum of the probability values associated with the group of sensors; and
the location of the anomaly in the gas distribution network is determined as being within a region defined based on the group of sensors.

19. A computer program product, embodied in one or more non-transitory computer-readable storage mediums, comprising instructions executable by at least one processor to perform a method of monitoring a gas distribution network operating at low pressure, using at least one processor, the method comprising:
obtaining sensor data from a plurality of sensors in the gas distribution network configured to detect at least one characteristic of gas flow through the gas distribution network;
extracting at least a first type of features from the sensor data;
detecting one or more anomalies in the gas distribution network based on at least the first type of features extracted; and
determining a location of the one or more anomalies in the gas distribution network based on at least the first type of features extracted.
